(19) United States
(12) Patent Application Publication
(10) Pub. No.: US 2022/0126990 A1
(43) Pub. Date: Apr. 28, 2022

(54) DOUBLE-BLADE TANDEM HELICOPTER

(71) Applicant: X-CONTROL SYSTEM CO., LTD., Beijing (CN)

(72) Inventor: Fan Yang, Beijing (CN)

(21) Appl. No.: 16/476,519

(22) PCT Filed: Jun. 30, 2015
(86) PCT No.: PCT/CN2015/082752

§ 371 Date: Jul. 8, 2019

(51) Int. Cl. B64C 27/08; B64C 27/32; B64C 27/473; B64C 27/467

(52) U.S. Cl. CPC B64C 27/08; B64C 27/32; B64C 2027/4736; B64C 27/467; B64C 27/473

(57) ABSTRACT

A double-blade tandem helicopter comprising a fuselage (10), a power system, a control system, and two rotor assemblies (30, 50). The rotor assemblies are longitudinally disposed relative to the fuselage. Each rotor assembly comprises a rotor shaft (31, 51), a rotor head (33, 53), and two blades (35, 37, 55, 57). The rotor shaft is connected to the power system, the rotor head is fixed to the rotor shaft, and the blades are attached to the rotor head. The double-blade tandem helicopter has a larger rotor disk area than that of a single-rotor helicopter while has a fuselage weight approaching that of the single-rotor helicopter, and thus has a take off weight approximately twice or more times of the single-rotor helicopter, and meanwhile has characteristics such as small volume, simple structure and high aerodynamic efficiency.

### FIELD OF THE DISCLOSURE

The present disclosure relates to a helicopter, in particular to a double-blade tandem helicopter.

### BACKGROUND OF THE DISCLOSURE

As an aircraft that can take off and land vertically, a helicopter is prominently characterized in that it can make low-altitude and low-speed maneuver with an orientation of the helicopter head unchanged, especially can take off and land vertically in a small-area site. Because of these characteristics, it has broad application and development prospects in military aspects (such as ground attack, landing, logistic support, etc.) or civilian aspects (such as short-distance transportation, medical rescue, disaster relief, geological exploration, etc.). The helicopter is generally composed of a fuselage, a power system, a control system and a lift system. The lift system that enables the helicopter to take off and land vertically is very important for the helicopter, and it mainly includes a rotor assembly. At present, helicopters are mainly classified into five categories: single rotor type, tandem type, horizontal type, coaxial type and intermeshing rotors type.

For a single-rotor helicopter, the takeoff weight can be increased by increasing the number of blades and the length of the blades. A maximum takeoff weight of a helicopter is an important index for measuring the performance of the helicopter. Generally, the maximum takeoff weight is increased by increasing the “rotor disk area” or increasing the number of blades. “Rotor disk area” refers to the area of the disk formed by the radius of the rotor in a plane formed by the rotor. However, a single-rotor helicopter requires a tail rotor to balance a counter-torque generated by a main rotor, so the tail rotor consumes about 20% of the engine power. Moreover, the tail rotor must be outside the main rotor, so as the length of the blade increases, the tail length of the helicopter increases accordingly, and meanwhile the length of the helicopter nose should also increases to balance the weight of the tail to ensure that the center of gravity of the fuselage is near the center of the main rotor, causing the increase of the weight the fuselage. Therefore, the greater the takeoff weight of the single-rotor helicopter is, the lower the efficiency is.

For multi-blade tandem helicopters, when the rotors are in the same size, the rotor disk area with the same number of blades can increase approximately one time. However, since it is necessary that rotors do not interfere with each other during operation, a distance between shafts of the two rotor assemblies is larger than the radius of the rotor, and the larger the number of blades is, the larger the shaft distance is. Disk overlapping is described with an overlap rate ov, namely, ov=1-ds/d, wherein ds is the shaft distance between the rotors, and d is a diameter of a rotor disc. The overlap rate of the rotor disks of a tandem helicopter with three rotors/per set is generally smaller than 34%, and the overlap rate of the rotor disks of a tandem helicopter with four rotors/per set is generally smaller than 22%. The smaller the overlap rate is, the larger the shaft distance is, the larger the size and weight of the fuselage is. Accordingly, it is necessary to increase weight of extra structures to maintain the rigidity of the fuselage. Meanwhile, an excessively large fuselage will block a downwash stream of the rotor, reduces the lift and lowers the aerodynamic efficiency.

A multi-blade transverse helicopter generally does not have a rotor disk overlap, and meets a large forward flight resistance. Hence, this design is seldom used.

A coaxial helicopter has two rotors arranged one above the other, which rotate in opposite directions about one axis. The rotor discs overlap in a large area, which therefore lowers the aerodynamic efficiency.

The two sets of rotors of the intermeshing rotors helicopter have a very small distance between the rotor shafts, so the rotor disk area slightly increases relative to the same-sized single-rotor helicopter. The design without the tail rotor can effectively use the engine power. However, a heading control capability of such helicopter is poor. Like the coaxial helicopter, the intermeshing rotors helicopter further needs a tail rotor extending out of the main rotor to provide extra heading stability. Therefore, the size of the fuselage is just slightly shortened as compared with the single-rotor helicopter.

Although the above various helicopters have already been developed, the current helicopters still have drawbacks such as a small rotor disk area, a large fuselage size and a low aerodynamic efficiency. It is very desirable to provide a novel helicopter that can overcome drawbacks of the above various helicopters.

### SUMMARY OF THE DISCLOSURE

An object of the present disclosure is to provide a novel helicopter and particularly a double-blade tandem helicopter, which can overcome drawbacks of conventional helicopters such as a small rotor disk area, a large fuselage size and a low aerodynamic efficiency.

The helicopter according to the present disclosure has a smaller fuselage size than a single-rotor helicopter, an intermeshing rotors helicopter and large-load helicopters such as multi-blade tandem or transverse helicopters with the same rotor size.

The helicopter according to the present disclosure has a larger rotor disk area with the weight of helicopter body being close to that of the single-rotor helicopter, and has a lift weight approximately twice or more times of the single-rotor helicopter.

The helicopter according to the present disclosure exhibits s a small volume, a simple structure and a high aerodynamic efficiency.

According to one aspect of the present disclosure, there is provided a double-blade tandem helicopter, comprising: a fuselage, a power system, a control system and a lift system, wherein the lift system comprises two rotor assemblies, and the two rotor assemblies are arranged along a longitudinal direction of the fuselage. The two rotor assemblies form the same rotor disk diameter as each other and rotate synchronously in opposite directions. Each rotor assembly comprises: a rotor shaft pivotally coupled to the power system; a rotor head fixedly coupled to an upper end of the rotor shaft, and two blades arranged around the rotor head in a linear configuration. As being driven by the power system, the two rotor shafts drive the rotor head and thus the blades to rotate.

The layout of the double-bladed tandem helicopter according to the present disclosure is a layout between an intermeshing rotors helicopter and a multi-blade tandem helicopter, and comprises two rotor assemblies longitudinally arranged. However, each rotor assembly comprises two blades which may have a larger overlap rate, namely, the shaft distance of the double-blade tandem helicopter is smaller than the multi-blade tandem helicopter and larger than the intermeshing rotors helicopter. Hence, the double-blade tandem layout of the helicopter according to the present disclosure has the following advantageous effects:

1) Increasing the overlap rate of the rotor disk which can be increased to about 45%, shortening the distance between shafts of the two rotor assemblies, shortening the length of the fuselage to be significantly smaller than other helicopters of the same rotor size, for example, the fuselage length can be shortened by more than about 15% as compared with the 3-blade rotor helicopter and can be shortened by more than about 29% as compared with the 4-blade rotor helicopter. Therefore, the volume of the helicopter body is reduced, air resistance is decreased and the fuselage weight is reduced. In a case, the weight of the fuselage of the helicopter according to the present helicopter is close to that of the single-rotor helicopter and intermeshing rotors helicopter with the same rotor size, and smaller than that of the multi-blade tandem helicopter;

2) The helicopter according to the present disclosure has handling dimension (in a rotor-removed or folded state) smaller than other helicopters with the same rotor size; 3) As compared with single-rotor and intermeshing rotors helicopters of the same rotor size, the helicopter of the present disclosure can significantly increase the rotor disk area and lift weight, wherein the rotor disk area can be increased by more than about 67% (inversely proportional to the overlap rate), and the lift weight can be increased by more than about 65%;

4) The number of blades in each rotor assembly is small, the eddy current interference between the rotors is reduced, the rotor heads are simple in structure, and the load of the reduction gearbox is low;

5) The helicopter according to the present disclosure has characteristics of the multi-blade tandem helicopters such as aerodynamic symmetry, a high flying speed and insensitivity to the center of gravity.

The double-blade tandem helicopter of the present disclosure can realize a larger rotor disk area with a smaller fuselage size, which improves the load capacity, reduces eddy current interference between blades, improves aerodynamic efficiency, and is irrelevant to the rotor head structure, rotor shape, rotation direction, control, power system, fuselage shape, landing gear form, etc.

### BRIEF DESCRIPTION OF DRAWINGS

FIG. 1 is a side view of a double-blade tandem helicopter according to a preferred embodiment of the present disclosure.

FIG. 2 is a top view of the double-blade tandem helicopter shown in FIG. 1.

### DETAILED DESCRIPTION OF PREFERRED EMBODIMENTS

Hereinafter, a novel helicopter of the present disclosure will be described in detail with reference to the figures. What are presented are merely preferred embodiments according to concepts of the present disclosure. Those skilled in the art can envisage other embodiment for implementing the present disclosure. Directional terms such as “front”, “rear”, “left” and “right” employed herein are relative to the aircraft fuselage.

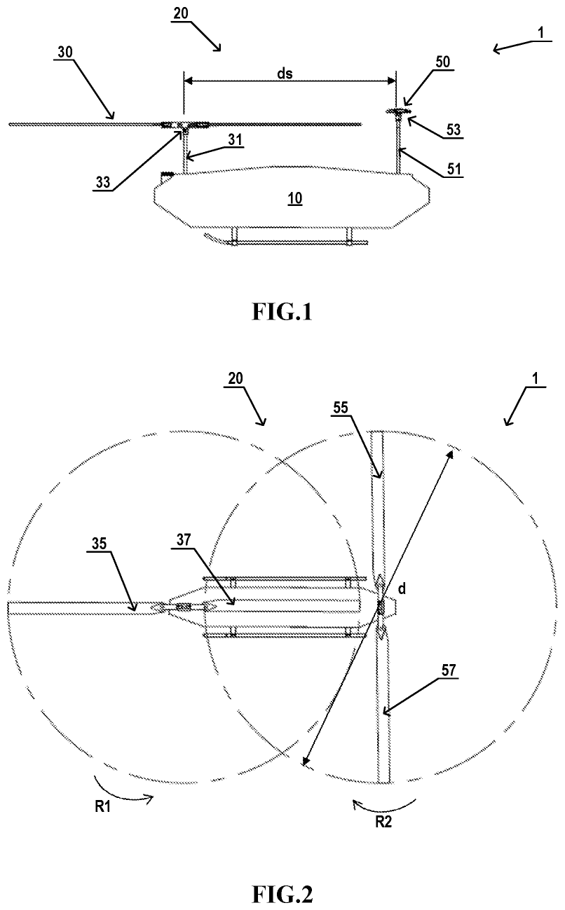

FIG. 1 is a side view of a double-blade tandem helicopter according to a preferred embodiment of the present disclosure, and FIG. 2 is a top view of the double-blade tandem helicopter shown in FIG. 1. As shown in FIGS. 1 and 2, the double-blade tandem helicopter 1 according to a preferred embodiment of the present disclosure comprises: a fuselage 10; a power system (not shown); a control system (not shown); and a lift system 20. The lift system 20 according to the present disclosure includes a first rotor assembly 30 and a second rotor assembly 50. The first rotor assembly 30 and the second rotor assembly 50 are arranged with a distance ds therebetween along a longitudinal direction of the fuselage 10, the first rotor assembly 30 is arranged at the front of the fuselage 10, and the second rotor assembly is arranged at the rear of the fuselage 10.

As shown in FIG. 1, the first rotor assembly 30 includes: a rotor shaft 31 pivotally coupled to the power system at the front of the fuselage 10, a rotor head 33 fixedly coupled to an upper end of the rotor shaft 31, and a first blade 35 and a second blade 37 arranged around the rotor head 33 in linear configuration. Similarly, the second rotor assembly 50 includes: a rotor shaft 51 pivotally coupled to the power system at the rear of the fuselage 10, a rotor head 53 fixedly coupled to an upper end of the rotor shaft 51, and a third blade 55 and a fourth blade 57 arranged around the rotor head 53 in linear configuration. When driven by the power system, the rotor shafts 31 and 51 drive the rotor heads and blades to rotate.

In an embodiment, a diameter d of the disk formed by the first blade 35 and the second blade 37 of the first rotor assembly 30 is the same as a diameter d of the disk formed by the third blade 55 and the fourth blade 57 of the second rotor assembly 50. Furthermore, the first rotor assembly 30 rotates in a first direction R1 and the second rotor assembly 50 rotates in a second direction R2 opposite to the first direction R1 (as shown in FIG. 2). According to the configuration of the present disclosure, the distance ds between the two rotor shafts 31 and 51 may be between 55% and 70% of the diameter d of the rotor disc. The rotor disk overlap rate may be between 30% and 45%.

Preferably, the rotor heads 33, 53 may be fully-flapping rotor heads, i.e., the blades can perform pitching, yawing and rolling motion relative to the rotor heads to a certain degree. In other preferred embodiments, the rotor heads 33 and 53 may be replaced with rigid rotor heads or hingeless rotor heads in which blades cannot move relative to the rotor heads, or see-saw type rotor heads in which blades can perform pitch or yaw motion relative to the rotor heads to a certain degree.

In a preferred embodiment, the rotor head 53 of the second rotor assembly 50 is located at a higher level than the rotor head 33 of the first rotor assembly 30 relative to the fuselage 10.

In another preferred embodiment, the rotor head 33 of the first rotor assembly 30 and the rotor head 53 of the second rotor assembly 50 are located at the same level relative to the fuselage 10.

In a preferred embodiment, axes of the rotor shafts 31 and 51 are located in a longitudinal vertical plane of the fuselage 10, and are parallel to each other and perpendicular to the fuselage 10.

In a further preferred embodiment, axes of the rotor shafts 31 and 51 are located in a longitudinal vertical plane of the fuselage 10, and are not parallel to each other and intersect below the fuselage 10.

In a preferred embodiment, a material of an inner layer of the blade is glass fiber and a material of an outer layer is carbon fiber.

In other preferred embodiments, the material of the blade is one of glass fiber and carbon fiber.

In a preferred embodiment, the blade is symmetrical airfoils, and upper and lower surfaces of the blade are symmetrical.

In other preferred embodiments, the blade is asymmetrical airfoil, and upper surface of the blade is convex and lower surface is flat.

The double-blade tandem helicopter according to the present disclosure has a weight of the helicopter body approximate to that of a single-rotor helicopter, a larger disk area, and a lift weight approximately twice or more times of the single-rotor helicopter. Meanwhile, the double-blade tandem helicopter has characteristics such as a small conveying volume, a simple structure and a high aerodynamic efficiency.

From the above contents, those skilled in the art will readily appreciate that alternative structures of the disclosed structures may be considered as possible alternative embodiments, and that embodiments disclosed by the present disclosure may be combined to produce new embodiments without departing from the scope of the appended claims.

1. A double-blade tandem helicopter, comprising:
a fuselage;
a power system;
a control system; and
a lift system comprising two rotor assemblies arranged along a longitudinal direction of the fuselage, each rotor assembly comprising:
a rotor shaft pivotally coupled to the power system;
a rotor head fixedly coupled to an upper end of the rotor shaft; and
two blades arranged around the rotor head in linear configuration.

2. The double-blade tandem helicopter according to claim 1, wherein blades of the two rotor assemblies form the same rotor disk diameter and rotate synchronously in opposite directions.

3. The double-blade tandem helicopter according to claim 1, wherein an overlap rate of rotor discs formed by the blades of the two of rotor assemblies is between 30% and 45%.

4. The double-blade tandem helicopter according to claim 2, wherein an overlap rate of rotor discs formed by the blades of the two rotor assemblies is between 30% and 45%.

5. The double-blade tandem helicopter according to claim 1, wherein the rotor heads are located at the same level relative to the fuselage.

6. The double-blade tandem helicopter according to claim 1, wherein the rotor head arranged at the rear of the fuselage is located at a higher level than the rotor head arranged at the front of the fuselage relative to the fuselage

7. The double-blade tandem helicopter according to claim 1, wherein the rotor head is a rigid rotor head, a hingeless rotor head, a see-saw type rotor head or a fully-flapping type rotor head.

8. The double-blade tandem helicopter according to claim 1, wherein axes of the rotor shafts are located in a longitudinal vertical plane of the fuselage, and are parallel to each other and perpendicular to the fuselage.

9. The double-blade tandem helicopter according to claim 1, wherein axes of the rotor shafts are located in a longitudinal vertical plane of the fuselage, and are not parallel to each other and intersect below the fuselage.

10. The double-blade tandem helicopter according to claim 1, wherein a material of an inner layer of the blade is glass fiber and a material of an outer layer of the blade is carbon fiber.

11. The double-blade tandem helicopter according to claim 1, wherein a material of the blade is one of glass fiber and carbon fiber.

12. The double-blade tandem helicopter according to claim 1, wherein the blade has a symmetrical airfoil or an asymmetrical airfoil.
